(19) United States
(12) Patent Application Publication
(10) Pub. No.: US 2016/0249430 A1
(43) Pub. Date: Aug. 25, 2016

(54) LED Color Bulb - Color Is Changeable by Flipping Power On/Off Switch

(71) Applicants: Wen-Chau Wayne Hou, Cupertino, CA (US); Gary JUN LIANG Lin, San Jose, CA (US); Ekram Bhuiyan, San Jose, CA (US)

(72) Inventors: Wen-Chau Wayne Hou, Cupertino, CA (US); Gary JUN LIANG Lin, San Jose, CA (US); Ekram Bhuiyan, San Jose, CA (US)

(21) Appl. No.: 14/629,495

(22) Filed: Feb. 24, 2015

(51) Int. Cl. H05B 33/08

(52) U.S. Cl. CPC H05B 33/0857

(57) ABSTRACT

The invention is a new type of color bulb, in which its color control circuit is built inside or connected to the bulb itself. The desired bulb color can be controlled through a device inside the bulb. The new invented bulb can be a LED type of bulb or any electrical lighting device. The invented bulb can be connected into an existing bulb holder (screw type or any other kinds of connector) and people can change its color by only using the existing power switch without any external control circuit or device.

### FIELD OF THE INVENTION

The invention is a new color bulb which can be used to decorate house, light fish tank, or other purposes with multiple colors which is generated from light-emitting diode (LED). Color changing of the invented bulb is controlled through regular wall power on/off switch, or any switches with no external control circuit. The invented bulb can have a traditional screw head, a pin head or any kind of electrical connector. The invented bulb seamlessly replaces any kind of bulb.

### BACKGROUND OF THE INVENTION

This invention relates generally to the field of apparatus for a LED Color Bulb. Moreover it pertains specifically to such apparatus for bulb color control by using the regular power on/off switch. With a specific color changing control circuit designed into the bulb, there is no need to add external color control device or circuit to the existing electrical system. The color of the bulb can be programmed according to the preset configuration by using the existing electrical switch with or without addition circuitry.

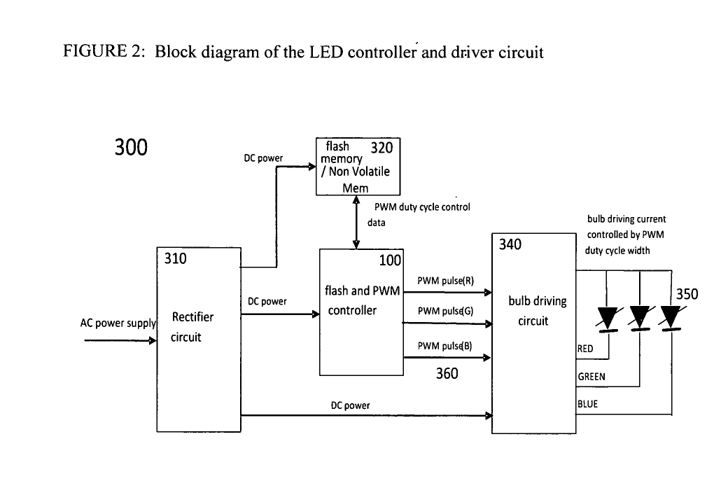

The driving circuit design of the invented LED color bulb is shown in FIG. 2. A rectifier circuit 310 connected to a power supply through a power switch for converting an input AC voltage to a DC voltage. The DC voltage is then provided to the lamp drive circuit, the flash controller, the flash memory, and the LED diodes. The LED color bulb includes one or more color LED diodes as light sources. The LED color diodes can be different color combination diodes. The method of changing the color of the bulb is to apply a Pulse Width Modulation (PWM) voltage to each of the LED color diodes (red, green, and blue diodes) to control the combination ratio of each light color. The current of each LED color diode is proportional to the duty cycle of the PWM signal. So, by adjusting the PWM duty cycle of each diode, the bulb color can be changed and controlled. The invention is to use one or multiple nonvolatile memory and/or one or multiple devices to achieve the adjustment of the PWM duty cycle of each color whenever the power switch is turned on and off. The color configuration can be stored in the nonvolatile memories. By controlling the LED color or color combination ratio, all different color of the bulb can be achieved.

### SUMMARY OF THE INVENTION

In view of the limitations now present in the prior art, the presented invention provides a new type of color light bulb which has the color control built inside the bulb or connected to the bulb. The invented bulb can be smoothly screwed into an existing lamp holder, (screw type or any other types). With the invented bulb, no external color control circuit is required to change its color; the control of the color setting is set through the existing switch infrastructure.

The type of bulb can be LED or any electricity powered bulb. One of the main advantage of the invented color bulb is that people can use only one bulb to emitting multiple colors by using the existing on/off switch without replacing the bulbs every time if want to change the color of the environment.

The ways to incorporate the color control into the bulb can be multifarious. The integrated controller or adapter based on the signal (power switch on/off sequences) determines the bulb color accordingly. The bulb color change in the invention is accomplished by using one or multiple nonvolatile memory with an integrated or separated controller. The color setting and control mechanism of the new invention can be accomplished by using the existing switch infrastructure with/without addition circuitry installed.

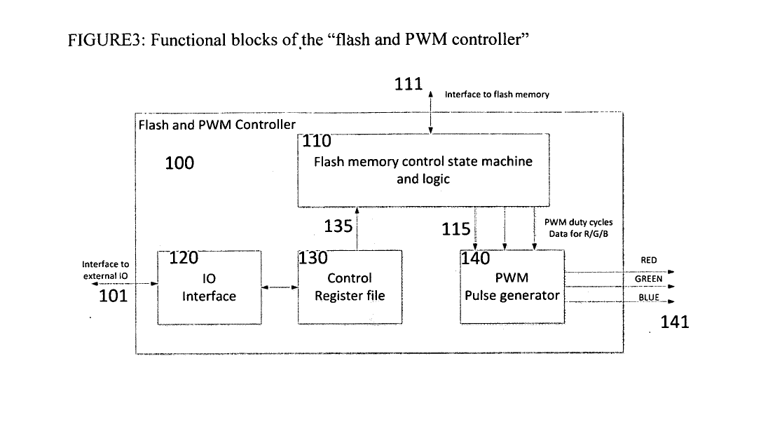

The color bulb includes one or more LED color diodes as the source of different light frequency emitter (color of light). For example, as shown in FIG. 2 and FIG. 3 three LED 350 color diodes can be used to generate any light combinations. The three LED color diode are red, green, and blue color diodes. By combining the three colors of light with different intensity ratio, all kinds of light color can be produced. Moreover, the color diode intensity is dependent on the duty cycle of the PWM voltage 360 that driving on it. The technique to control the color change of the bulb in this invention is to use the preserved data to adjust the duty cycle of the PWM signal for each of the three LED color diodes in the bulb. The preserved data can be stored in a dedicated flash memory 320 or any nonvolatile memories. The nonvolatile memory retains the updated PWM duty cycle data whenever the power is off. The stored setting is restored when the user turns on the power switch

Following is a sequence to describe how the driving PWM duty cycle of each color can be adjusted by turning on and off the power switch and turn out to control the color of the bulb.
At first time power on, the preserved data of the PWM duty cycle width for all three color diodes in the flash memory is read through the flash memory controller 330 and to set the three LED color diodes 350 at certain light intensity level. The combination of those three diodes lighting produces the bulb color.
At this time, the flash memory controller 330 calculates the three diodes' PWM driving data to be the next color value and the state machine in the flash memory controller writes the updated PWM duty cycle data (next color) back to the flash memory. This step completes in a very short time.
At the moment, when the power switch is turned off, the PWM duty cycle data of the three diodes for next color has been stored and retained in the flash memory.
The power switch is turned on again. Now the data in the flash memory is read again through the controller and which is then used to drive the duty cycle of the PWM of the three diodes. The combination of the three color lights produces the bulb color.
At this time, the flash memory controller calculates the three diodes' PWM driving data to be the next color value again and writes the updated PWM duty cycle data (next color) back to the flash memory.
Continues with the above operation loop, all the designed colors of the bulb can be displayed one by one.

### BRIEF DESCRIPTION OF THE DRAWINGS

The foregoing and other objects, features and advantages of the invention will be apparent from the following more particular description of preferred embodiments of the invention, as illustrated in the DRAWING section, in which like reference characters refer to the same parts throughout different views. The drawings are not meant to limit the invention to particular mechanisms for carrying out the invention in practice, but rather, the drawings are illustrative of certain ways of performing the invention.

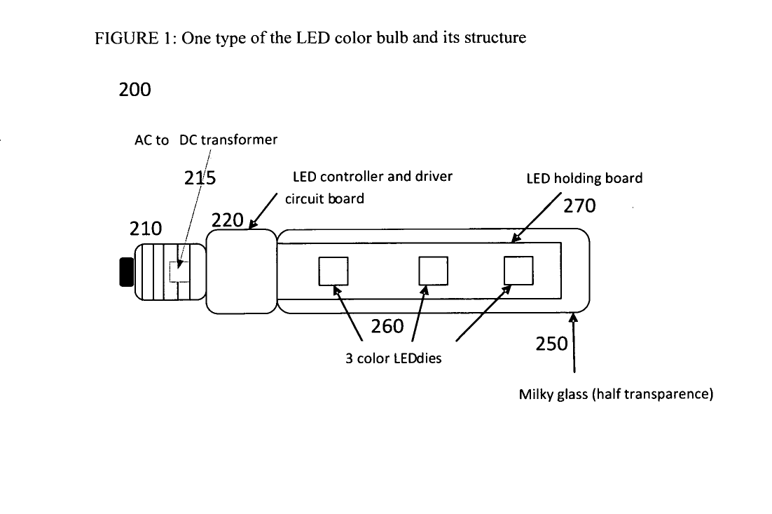

In FIG. 1, one type of the LED color bulb and its structure is shown. The LED color bulb typically includes following parts: An interface connector (screw head in this example) 210, an AC to DC transformer 215, a LED controller and driver circuit board 220, some three color (red, green, and blue diodes) LED diodes 260, the LED holding board 270, and the external milky glass 250.

The invented LED color bulb has the major LED controller and circuit board design, as shown in FIG. 2. The circuit board includes some functional blocks, such as the “rectifier circuit” 310, the “flash and PWM controller” 100, the “bulb driving circuit” 340, and the “flash memory” 320. The main invention of the LED color bulb is the “flash and PWM controller” 100 and the usage of the “flash memory” 320.

In FIG. 3, the “flash and PWM controller” 100 is described. The “flash and PWM controller” module includes few major blocks, IO interface 120, control register file 130, flash memory control state machine and logic 110, and the PWM pulse generator 140.

The IO interface block 120 provides the path for the programmability of the control register 130 file from external of the bulb. In simple bulb design, since there is no external IO interface designed, the registers inside the control register file will be hard coded to certain values. The IO interface 120 block is reserved in the design for advanced intelligent bulb programming capability.

### DETAILED DESCRIPTION OF THE INVENTION

The invented LED color bulb 200 can be any shape. One of popular shape is illustrated as in FIG. 1. The LED color bulb typically includes following parts: An interface connector (screw head in this example) 210, an AC to DC transformer 215, a LED controller and driver circuit board 220, some three color (red, green, and blue diodes) LED diodes 260, the LED holding board 270, and the external milky glass 250.

The invented LED color bulb has the major LED controller and circuit board design, as shown in FIG. 2. The circuit board includes some functional blocks, such as the “rectifier circuit” 310, the “flash and PWM controller” 100, the “bulb driving circuit” 340, and the “flash memory” 320. The main invention of the LED color bulb is the “flash and PWM controller” 100 and the usage of the “flash memory” 320. The “flash and PWM controller” 100 is further described in detail in FIG. 3.

The “flash and PWM controller” module includes few major blocks, IO interface 120, control register file 130, flash memory control state machine and logic 110, and the PWM pulse generator 140.

The IO interface block 120 provides the path for the programmability of the control register 130 file from external of the bulb. In simple bulb design, since there is no external IO interface designed, the registers inside the control register file will be hard coded to certain values. The IO interface 120 block is reserved in the design for advanced intelligent bulb programming capability.

The control register 130 file includes a few registers which are used to control the flash interface state machine 110, and the PWM pulse generation 140.

The flash memory control state machine 110 block is mainly used to control the write/read accesses to the flash memory. There is a main state machine inside the flash memory control state machine block which is designed to generate all the flash memory assessing commands (such as write, read, erase, etc) based on different conditions. For example, after power on reset, the state machine will issue a read command to the flash memory to read back the preserved PWM duty cycle data of each LED color diode and drive the PWM signals to the bulb driving circuit accordingly.

The PWM pulse generator 140 block controls the duty cycle of the PWM signals that are sent to the bulb driving circuit to control the intensity of each red, green, and blue color and turns out to control the color of the bulb. The generated duty cycle width is based on the inputs PWM pulse data from the flash memory control state machine and logic block (as shown in FIG. 3).

With the control circuit described above, the bulb's color control by using the power on and off switch can be achieved with following sequences:

Bulb color control sequence by continuously turning on and off of the power switch:
At first time power on, the preserved data of the PWM duty cycle width for all three color diodes in the flash memory is read through the flash memory controller and to set the three LED color diodes at certain light intensity level. The combination of those three diodes lighting produces the bulb color.
At this time, the flash memory controller calculates the three diodes' PWM driving data to be the next color value and the state machine in the flash memory controller writes the updated PWM duty cycle data (next color) back to the flash memory. This step completes in a very short time.
At the moment, when the power switch is turned off, the PWM duty cycle data of the three diodes for next color has been stored and retained in the flash memory.
The power switch is turned on again. Now the data in the flash memory is read again through the controller and which is then used to drive the duty cycle of the PWM of the three diodes. The combination of the three color lights produces the bulb color.
At this time, the flash memory controller calculates the three diodes' PWM driving data to be the next color value again and writes the updated PWM duty cycle data (next color) back to the flash memory.
Continues with the above operation loop, all the designed colors of the bulb can be displayed one by one.

What is claimed is:

1. A method comprising:
Providing an electrical bulb with an integrated control circuit and at least three light emitting diodes, with each of the at least three light emitting diodes having at least one color of red, green, and blues colors. The electrical bulb color setting may be changed by turning the power supply on and off.

2. The method of claim 1, further comprising controlling the electrical bulb color setting by retrieving the state of the current lighting setting from the non-volatile storage memory.

3. The method of claim 1, further comprising controlling the electrical bulb color setting by preserving the PWM duty cycle control data in the non-volatile storage to achieve the bulb color changing purpose.

4. The method of claim 1, further comprising controlling the electrical bulb color setting with no additional external wiring or control circuit outside of the bulb except a power on/off switch.

5. The method comprising of the power learn capability built into the light bulb. The color setting will be stored after the light bulb is turned on for a preset amount of time.

6. The light bulb of claim 6, has the power learn capability, which is accomplished through the usage of a flash memory (or the nonvolatile memory) the flash memory controller and a certain operation sequence.

7. The light bulb of claim 6, uses the flash memory or any nonvolatile memory to store the preserved PWM duty cycle control data and to achieve the discrete power level (dimming) control purpose.
